(19) United States
(12) Patent Application Publication
(10) Pub. No.: US 2025/0315720 A1
(43) Pub. Date: Oct. 9, 2025

(54) INTEGRATED MULTIMODAL ARTIFICIAL INTELLIGENCE FRAMEWORK FOR AUTOMATED PROVISIONING SYSTEMS

(71) Applicant: BANK OF AMERICA CORPORATION, Charlotte, NC (US)

(72) Inventors: Pratap Dande, Saint Johns, FL (US); Elvis Nyamwange, Little Elm, TX (US); Sarveshwar Kuncha, Frisco, TX (US)

(73) Assignee: BANK OF AMERICA CORPORATION, Charlotte, NC (US)

(21) Appl. No.: 18/628,410

(22) Filed: Apr. 5, 2024

(51) Int. Cl. G06N 20/00

(52) U.S. Cl. CPC G06N 20/00

(57) ABSTRACT

Systems, computer program products, and methods are described herein for an integrated multimodal artificial intelligence framework for automated provisioning systems. The present disclosure is configured to aggregate and process data from multiple sources, apply advanced machine learning techniques for data normalization, feature extraction, and pattern recognition, and integrate these capabilities into an automated workflow for application provisioning. The system utilizes a processing device and non-transitory storage containing instructions which, when executed, enable the handling of complex workflows, decision-making processes, and real-time error management. Incorporating voice recognition, the system allows for natural language user interactions, enhancing accessibility and efficiency. The AI-driven framework adapts to evolving operational needs, ensuring precise and resilient application deployment within dynamic environments.

### TECHNOLOGICAL FIELD

Example embodiments of the present disclosure relate to an integrated multimodal artificial intelligence framework for automated provisioning systems.

### BACKGROUND

Large institutions have historically grappled with the integration of emerging technologies into their operational framework, particularly in the automation of complex workflows and decision-making processes. Traditional systems often rely heavily on manual oversight and intervention, leading to inefficiencies, increased error rates, and delays in process execution.

Furthermore, the dynamic nature of operations, characterized by frequent updates to processes and the introduction of new services, exacerbates these challenges. These systems' inability to adapt quickly to changes or efficiently manage exceptions and errors has underscored the need for a more agile and intelligent approach. The advent of artificial intelligence (AI) offers a promising solution, yet its integration into various systems has been limited by the complexity of workflows and the diverse nature of tasks and data involved. Recognizing these challenges, the applicant has embarked on a journey to harness the capabilities of AI, specifically through a multimodal approach that combines various AI disciplines, to address these enduring issues. This has culminated in the development of a groundbreaking AI system that promises to transform the landscape of banking operations, paving the way for more efficient, accurate, and adaptable processes.

Applicant has identified a number of deficiencies and problems associated with an integrated multimodal artificial intelligence framework for automated provisioning systems. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for an integrated multimodal artificial intelligence framework for automated provisioning systems. With regard to large institutional entity operations, the proliferation of complex workflows and the frequent need for manual intervention and error management present significant challenges. To address these, the invention introduces a sophisticated multimodal artificial intelligence (AI) system designed to enhance the efficiency, accuracy, and agility of application workflows. This AI system leverages a combination of natural language processing (NLP), computer vision, and machine learning modalities to autonomously monitor transactions, resource flows, account actions, decisions, and errors across disparate systems. By learning from patterns over time, the system gains a deep understanding of both existing and newly introduced processes. This enables the system to autonomously manage decision points, either by prompting for human intervention where necessary, or by executing manual steps and notifying support teams. Furthermore, the system is capable of processing exceptions by undertaking any necessary reprocessing of actions to expedite the triage process, thereby significantly improving the overall system's performance.

The integration of multimodal AI in the provisioning of application workflows represents a revolutionary step forward in the automation and optimization of banking operations. By analyzing textual descriptions and interpreting visual data, the system can automatically understand, extract, and classify critical workflow elements without human intervention, greatly reducing the potential for errors. Machine learning algorithms enable the system to adapt and improve over time, learning from historical data and user interactions to fine-tune its decision-making and error management capabilities. Additionally, the AI-powered virtual assistant component of the system enhances the user experience by providing contextual recommendations and facilitating intuitive interactions. Through continuous monitoring and analysis, the multimodal AI system identifies bottlenecks, detects anomalies, and recommends adjustments, ensuring optimal resource utilization and streamlined operations. This technological advancement not only promises significant efficiency gains and cost savings for large institutions but also represents a significant leap towards fully automated, intelligent financial systems.

As such, embodiments of the invention relate to systems, methods, and computer program products for an integrated multimodal artificial intelligence framework for automated provisioning systems, the invention including: aggregating raw data from multiple data sources, wherein the data sources comprise logs, text, audio inputs, and visual inputs, resulting in aggregated raw data; producing a pre-processed dataset via normalizing and cleansing the aggregated raw data; determining extracted features from the pre-processed dataset using a combination of natural language processing for text data and computer vision for visual data; integrating the extracted features into a multimodal AI model framework and training the multimodal AI model framework to recognize patterns and make decisions; validating the trained multimodal AI model framework using a validation dataset to ensure model performance meets predetermined accuracy, precision, and recall benchmarks; incorporating voice recognition capabilities to interpret natural language inputs from users and translate the natural language inputs into executable commands; monitoring application workflows in real-time with the trained multimodal artificial intelligent (AI) model framework to detect and classify system errors or exceptions; and executing a corrective action automatically or providing a recommendation for manual intervention to resolve the system errors or exceptions.

In some embodiments, aggregating raw data further comprises use of application programming interfaces (APIs) to automatically retrieve data from various application layers including user interfaces, middleware, and backend databases.

In some embodiments, normalizing and cleansing the aggregated raw data further comprises use of an outlier detection algorithms to identify and rectify anomalies within the data set.

In some embodiments, extracting features using natural language processing and computer vision further comprises applying recurrent neural networks for the text data and convolutional neural networks for the visual data.

In some embodiments, validating the trained multimodal AI model framework is performed continuously as part of an iterative development process, with each iteration refining the model based on feedback from an operational performance metric.

In some embodiments, the voice recognition capabilities comprise adapting to user-specific accents, dialects, and languages to improve the accuracy of voice-to-text conversions and system commands.

In some embodiments, executing corrective actions comprises an escalation protocol notifying a human operator when the error requires intervention other than a predetermined automated corrective measure.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-IC illustrates technical components of an exemplary distributed computing environment for an integrated multimodal artificial intelligence framework for automated provisioning systems, in accordance with an embodiment of the disclosure;

FIG. 2 illustrates an exemplary machine learning (ML) subsystem architecture 200, in accordance with an embodiment of the invention;

FIG. 3 illustrates a component diagram 300 for an integrated multimodal artificial intelligence framework for automated provisioning systems; and

FIG. 4 illustrates a process flow 400 for an integrated multimodal artificial intelligence framework for automated provisioning systems, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “artificial intelligence (AI)” refers to the branch of computer science dedicated to creating systems capable of performing tasks that would typically require human intelligence. These tasks include but are not limited to understanding natural language, recognizing patterns in data, making decisions based on complex or incomplete information, and learning from past experiences to improve future performance. AI encompasses a range of techniques and methodologies, including machine learning, natural language processing, and computer vision, among others, to enable machines to mimic cognitive functions associated with human minds such as learning, problem-solving, and perception.

As used herein, “multimodal artificial intelligence (AI)” refers to an advanced AI framework that combines several AI methodologies or modalities, such as natural language processing (NLP), computer vision, and machine learning, to interpret and act upon a wide array of data types. This multifaceted approach enables the AI system to draw upon the unique capabilities of each modality, facilitating a deeper and more comprehensive understanding of complex data. For instance, by integrating NLP for text analysis, computer vision for image and video interpretation, and machine learning for predictive analytics, the system can offer nuanced insights and make informed decisions that would be beyond the reach of single-modality AI systems. This holistic approach enhances the AI's adaptability and efficacy in diverse application scenarios, from customer service automation to sophisticated data analysis tasks, ensuring more accurate, responsive, and context-aware computing solutions.

As used herein, “natural language processing (NLP)” denotes a critical branch of AI concentrated on the interaction between computers and humans through natural language. The objective is to enable computers to understand, interpret, and generate human languages in a valuable and meaningful manner. Through various NLP techniques, such as parsing, semantic analysis, and language generation, the system can extract insights from textual data, facilitate human-computer dialogues, and generate human-like responses to queries. This capability is vital in numerous applications, including automated customer support, real-time language translation, sentiment analysis of social media content, and automatic summarization of large documents, thereby bridging the communication gap between humans and machines and unlocking new avenues for human-computer interaction.

As used herein, “computer vision” encompasses the AI domain that imparts machines with the ability to interpret and understand visual information from the surrounding world, akin to human vision. This involves the extraction of meaningful information from images and videos to make decisions or perform actions based on that visual input. Key tasks within computer vision include object recognition, facial recognition, pattern and anomaly detection, and scene reconstruction, which find applications in a wide range of fields from security surveillance systems and autonomous vehicles to diagnostics and retail analytics. By processing visual data, computer vision systems can automate tasks that require visual comprehension, significantly enhancing efficiency and accuracy in various industries.

As used herein, “machine learning” is identified as a vital subset of AI that equips computers with the ability to autonomously learn and improve from experience without being explicitly programmed for specific tasks. Through the analysis of large datasets and the identification of patterns within these datasets, machine learning algorithms can make predictions or decisions, thus enabling systems to adaptively enhance their performance over time based on new data. This capability is foundational for a plethora of applications, including predictive analytics, personalization services, detection, and more, across diverse sectors such as finance, retail, and beyond. Machine learning not only drives the evolution of AI technologies but also underpins the development of more intelligent, efficient, and personalized services.

As used herein, “provisioning application workflows” specifically refers to the orchestrated and automated configuration, deployment, and management of the processes and digital resources necessary for applications to function optimally within an organizational context. This involves streamlining the sequence of tasks required to make software applications ready for use, including setting up databases, configuring servers, and integrating application components. By automating these processes, organizations can rapidly and efficiently deploy and update applications, thereby significantly reducing the time and resources needed for manual setup and adjustments. This automation ensures that applications are consistently configured according to best practices and operational requirements, enhancing reliability, scalability, and security across the application lifecycle.

As used herein, “workflow automation” describes the application of technology to design, execute, and automate business processes based on predefined rules, where tasks, information, or documents are passed between participants according to a set sequence. This automation minimizes the need for manual input, thereby increasing operational efficiency, reducing the likelihood of errors, and ensuring tasks are completed within a shorter timeframe. Workflow automation is applicable across various organizational processes, from simple administrative tasks to complex operational workflows, enabling businesses to achieve greater productivity, improved accuracy, and enhanced compliance with regulatory standards. By streamlining these processes, organizations can allocate their resources more effectively, focusing on strategic activities that add greater value.

As used herein, “error management” refers to the systematic identification, analysis, and correction of errors or faults within the system. This includes the mechanisms and strategies employed to detect errors, diagnose their causes, and implement appropriate solutions or workarounds to ensure continuous system operation.

As used herein, “dataset collection” entails a meticulous procedure aimed at amassing and organizing a wide range of data from diverse sources to underpin the development, refinement, and assessment of AI models. This crucial initial step involves the compilation of varied types of data, including but not limited to textual content from documents or online sources, visual inputs such as images and videos, and operational metrics derived from system logs or performance reports. The objective of this collection is to ensure that AI models are exposed to a broad spectrum of data reflecting real-world scenarios and challenges they are expected to navigate. This rich dataset not only facilitates the comprehensive training of models but also enables their rigorous validation and testing, ensuring the models' robustness and reliability in practical applications. The dataset collection process is foundational in building AI systems that are well-rounded, versatile, and capable of understanding complex patterns and nuances inherent in the data they process.

As used herein, “data pre-processing” is described as a series of critical operations performed on raw data to render it suitable for analysis and modeling by AI systems. This preparatory phase includes a variety of actions such as cleaning the data to remove inaccuracies or inconsistencies, normalizing data to ensure uniformity in scale or format, and transforming data into a structured format more amenable to computational analysis. Additional pre-processing steps may involve the elimination of redundant or irrelevant features, handling of missing values, and the encoding of categorical variables. These efforts are essential to mitigate potential issues that could compromise the performance of AI models, ensuring that the data fed into these models is of the highest quality and structured in a manner that maximizes the efficacy of subsequent analyses and predictions.

As used herein, “textual and visual feature extraction” encompasses the processes employed to distill pertinent features or attributes from textual and visual data sources, which are instrumental for the analysis performed by AI models. In the context of textual data, feature extraction might involve the identification of key phrases, sentiment indicators, or syntactic patterns that are predictive of certain outcomes. For visual data, this process could entail the extraction of shapes, textures, colors, or spatial relationships that are significant for the task at hand. These extracted features serve as a condensed representation of the original data, capturing its most essential aspects in a form that AI models can efficiently process and analyze. The ability to accurately identify and extract relevant features is fundamental to the performance of AI systems, directly impacting their ability to learn from data and make informed decisions.

As used herein, “model training and validation” delineates the dual phases of AI model development where the model is first instructed (trained) to recognize patterns and deduce insights from a designated training dataset, and then its performance is rigorously assessed (validated) using a distinct dataset not previously encountered by the model. The training phase involves adjusting the model's parameters so that it can accurately predict outcomes or classify data points based on the input it receives. Following this, the validation phase tests the model's generalizability and accuracy on new data, ensuring that the insights or predictions it generates are reliable and applicable across different scenarios. This process not only certifies the model's effectiveness but also highlights areas for improvement, guiding further refinements to enhance its accuracy and robustness.

As used herein, “error detection and classification” characterizes the system's innate ability to autonomously identify discrepancies or anomalies within operational workflows and to categorize these identified errors based on predefined criteria. This critical functionality underpins the system's capacity to initiate prompt and appropriate corrective actions, thereby mitigating potential impacts on the system's performance or output quality. By systematically categorizing errors, the system can apply specialized resolution strategies tailored to the nature and severity of the error, streamlining the process. This capability is instrumental in maintaining the integrity and efficiency of automated workflows, ensuring that operations proceed smoothly and that any disruptions are swiftly and effectively addressed.

As used herein, “automated workflow” refers to a series of automated steps or processes that are executed without human intervention, based on predefined rules and criteria. These workflows streamline operations, ensuring tasks are performed more efficiently and consistently.

As used herein, “voice input integration” signifies the strategic embedding of voice recognition technologies within the AI system, enabling it to accurately interpret and act upon commands or inquiries articulated verbally by users. This integration significantly enhances the system's interactivity and accessibility, promoting a user-friendly environment where operations can be conducted without the need for manual input or navigation through complex interfaces. Voice input integration finds critical application in scenarios requiring hands-free operation, such as during driving or when multitasking, making technology more inclusive and adaptable to various user needs and situations. This feature not only streamlines interactions but also opens new avenues for engaging with technology, making digital services more intuitive and aligned with natural human communication patterns.

As used herein, “bottlenecks and anomalies” collectively describe operational or data-related issues that can adversely affect the efficiency and effectiveness of system processes. Bottlenecks are identified as specific points within a workflow or system architecture where the flow of operations is significantly slowed or impeded, leading to delays and reduced throughput. Anomalies, on the other hand, refer to irregular or unexpected patterns within the system's data or behavior that deviate from the norm, potentially indicating underlying problems or areas for improvement. The proactive identification and resolution of bottlenecks and anomalies are paramount for maintaining optimal system performance, facilitating smoother operations, and ensuring that resources are allocated and used as efficiently as possible. Addressing these issues promptly can lead to improved system reliability, higher user satisfaction, and the prevention of potential escalations that could impact service quality.

As used herein, “resource utilization” encompasses the strategies and practices aimed at maximizing the efficiency and effectiveness of the deployment and management of an AI system's resources. This includes judicious allocation and use of computational power, memory, data storage, and other critical system components to ensure that the system operates at optimal performance levels while minimizing unnecessary expenditure and waste. Effective resource utilization is crucial for scaling systems, handling varying loads, and maintaining responsiveness under different operational conditions. By optimizing how resources are used, organizations can achieve cost savings, reduce environmental impact, and support more sustainable growth. Furthermore, strategic resource management contributes to the system's resilience and adaptability, enabling it to better respond to evolving demands and technological advancements.

As used herein, “user interactions” denote the comprehensive range of engagements, inputs, and feedback exchanged between the AI system and its users. These interactions can vary widely, from direct commands and queries to more subtle forms of engagement, such as user behavior and preferences. Analyzing these interactions allows the system to better understand user needs, preferences, and patterns, facilitating continuous improvement in system design, functionality, and user experience. Effective management and analysis of user interactions are critical for personalizing the user experience, enhancing satisfaction, and building more intuitive and responsive AI systems. By leveraging insights gained from user interactions, developers can tailor the system to better meet user expectations and foster more meaningful and effective engagements with technology.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

As used herein, a “resource transaction processing entity” refers to an institution that specializes in the management, exchange, and safeguarding of monetary resources and related information for individuals and businesses. This entity operates through a sophisticated infrastructure designed to facilitate a wide range of transactions including deposits, withdrawals, loans, and investments. It employs advanced technological systems to ensure secure, efficient, and reliable processing of these transactions. Additionally, this institution may provide advisory services related to management, helping clients to achieve their economic objectives through strategic planning and execution. Through its comprehensive suite of services, it plays a pivotal role in the economic ecosystem, enabling the flow of resources within and between markets.

The present disclosure introduces a technology employing multimodal artificial intelligence (AI) to significantly enhance the operational efficiency of workflows within a resource transaction processing entity. This innovative technology seamlessly integrates a variety of AI methodologies, such as natural language processing (NLP), computer vision, and machine learning. Its core function is to autonomously monitor, analyze, and optimize the decision-making processes integral to these workflows, enabling a more streamlined and efficient operational framework.

The sector responsible for managing resources and processing transactions faces considerable obstacles in overseeing complex application workflows. These challenges are primarily due to manual decision points, cumbersome error management procedures, and the intricate task of integrating new processes into the existing framework. Such inefficiencies not only escalate error rates but also lead to considerable delays in process execution. Consequently, this not only undermines the overall performance of the system but also significantly detracts from customer satisfaction levels, presenting a critical need for a more efficient and error-resilient approach to managing these workflows.

In response to these challenges, the proposed solution leverages a multimodal AI system designed to automate decision points, enhance error management strategies, and streamline the process of integrating new workflows. This system is distinguished by its ability to learn from the patterns observed in system transactions, decision-making processes, and encountered errors. With this knowledge, the AI system is empowered to autonomously issue reminders for human-based decisions, perform manual steps on behalf of users, and alert support teams for necessary interventions. This capability is pivotal in not only enhancing the accuracy and agility of operations within the resource transaction processing entity but also in elevating the overall efficiency of its workflows.

The present disclosure details a multimodal AI system meticulously engineered to autonomously manage and refine the workflows associated with resource transaction processing. This system distinguishes itself by automating critical decision-making processes and error management tasks while ensuring the seamless integration of new processes. Such automation significantly diminishes the need for manual intervention, expedites the execution of processes, and bolsters system resilience in the face of errors and exceptions. Moreover, this AI system is designed with adaptability in mind, enabling continuous learning from new patterns and processes. This ensures that operations within the Resource Transaction Processing System not only maintain peak efficiency but also remain adaptive and responsive to the ever-evolving needs and expectations of the industry.

Accordingly, the present disclosure outlines a multimodal AI system designed to autonomously manage and optimize banking application workflows. This system not only automates decision-making processes and error management but also facilitates the seamless integration of new processes. By doing so, it significantly reduces the reliance on manual intervention, accelerates process execution, and improves system resilience against errors and exceptions. Furthermore, the system continuously learns and adapts to new patterns and processes, ensuring that operations remain efficient and responsive to evolving entity needs.

What is more, the present disclosure provides a technical solution to a technical problem. As described herein, the technical problem includes the inefficiency, high error rates, and delays in application workflows due to manual decision points, cumbersome error management, and the complexity of integrating new processes. The technical solution presented herein allows for the automation of these workflows, leveraging multimodal AI to enhance decision-making, error resolution, and process integration. In particular, this solution is an improvement over existing solutions to the identified problems by (i) automating tasks and decisions that previously required manual intervention, thus reducing the computing resources needed for process management; (ii) providing a more accurate and efficient method of error detection and resolution, thereby minimizing the resources expended on correcting errors; (iii) eliminating unnecessary steps and manual input, thus streamlining workflows and conserving computing resources; (iv) optimizing the use of system resources to implement solutions, thereby reducing network traffic and the load on computing infrastructures. Furthermore, the technical solution described herein employs a rigorous, computerized process to perform tasks and activities that were previously unmanageable through automation. In specific implementations, the technology bypasses traditional, labor-intensive steps, offering a more efficient use of computing resources and a significant advancement in the management of banking application workflows.

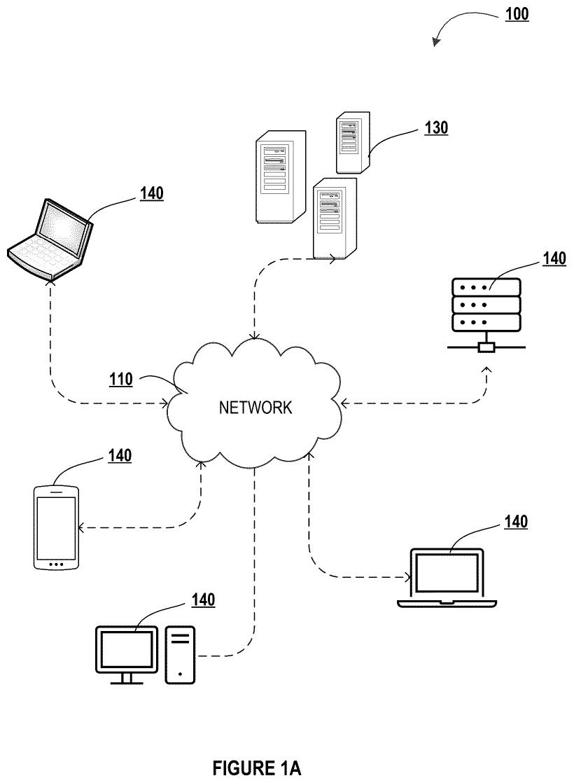

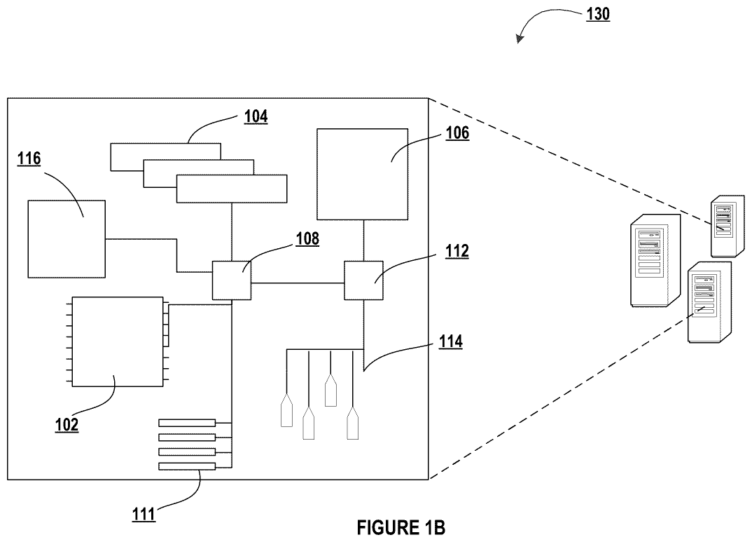

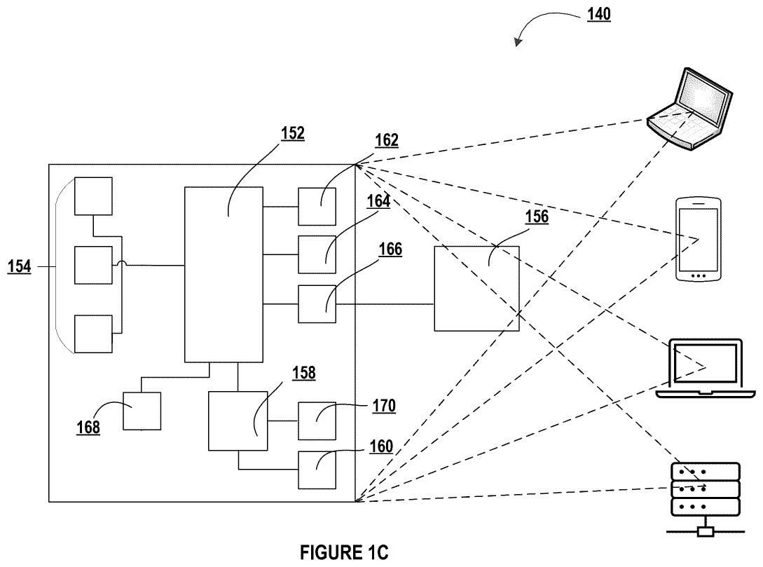

FIGS. 1A-IC illustrate technical components of an exemplary distributed computing environment 100 for an integrated multimodal artificial intelligence framework for automated provisioning systems, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

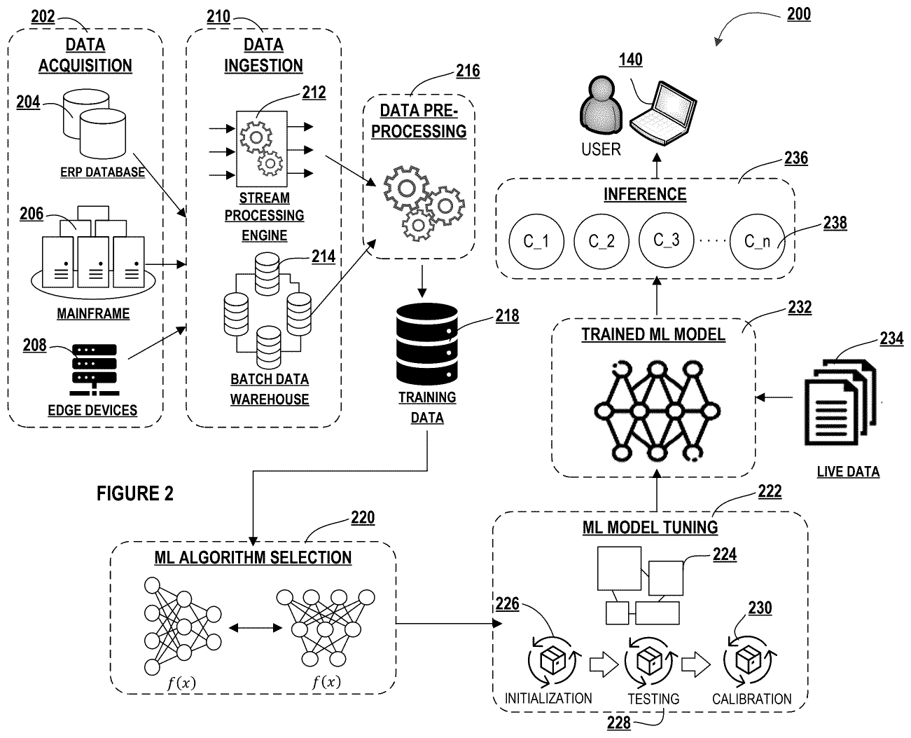

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

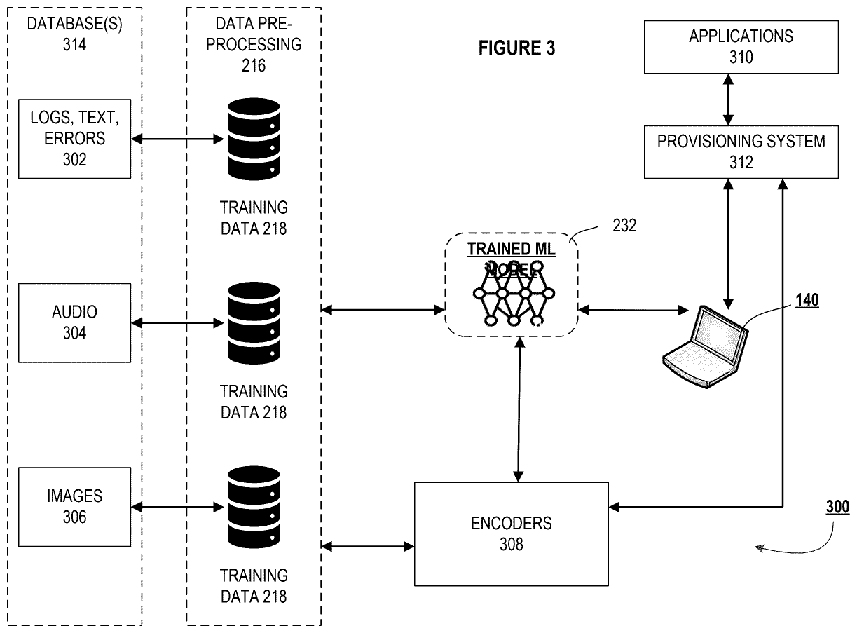

FIG. 3 illustrates a process flow for an integrated multimodal artificial intelligence framework for automated provisioning systems, in accordance with an embodiment of the disclosure. The process flow 300 initiates with the collection of various types of data from multiple databases, each tailored to store specific kinds of data inputs, such as logs, text, errors 302, audio 304, and images 306. These datasets are sourced from their respective database 314 inputs and subjected to data pre-processing 216, which includes cleaning, normalizing, and transforming the data to prepare it for subsequent analysis. The cleansed and structured training data 218 is then used to train the multimodal artificial intelligence models. In a data pre-processing stage, diverse datasets are cleansed and normalized, which is vital for the consistent interpretation of data by the system. This step eliminates anomalies that could lead to inaccuracies in the system's decision-making process, thus directly contributing to the reliability of the subsequent workflow provisioning. It includes textual data normalization by removing irrelevant words and reducing words to their base forms, as well as resizing and normalizing images for uniformity.

Textual and visual feature extraction modules employ advanced natural language processing techniques and convolutional neural networks, respectively. The NLP component extracts semantic meaning and contextual relationships within textual data, which is essential for understanding the detailed requirements and nuances of various entity processes. The computer vision component analyzes visual inputs to understand and capture the structural aspects of the workflows, which are often represented in complex graphical formats. These feature extraction processes transform raw data into a form that is actionable for AI models, underpinning the system's ability to understand intricate workflow components and dependencies. Following feature extraction, the multimodal AI models undergo rigorous training using the pre-processed and feature-enriched datasets. By utilizing a combination of neural networks and other machine learning architectures as described with regard to FIG. 2, the models learn to perform tasks such as predicting outcomes and classifying data, which are pivotal for automating decision points in entity workflows. This training phase is crucial for the models to accurately mimic the decision-making capabilities that would typically require human intelligence.

After the models are trained, they are validated and evaluated to ensure that they can generalize their learning to new, unseen data, thereby confirming their effectiveness and accuracy in live environments. This phase assesses the system's capabilities to automate workflows and manage exceptions without manual intervention.

Trained machine learning models 232 form the core of the AI system, where they are developed to predict outcomes, classify data, and facilitate decision-making processes. These models are trained on the pre-processed datasets to recognize patterns, interpret various data modalities, and learn from the inputs they receive. Once trained, these models are incorporated into the AI system where they continuously learn and adapt to new data in real-time. Encoders 308 play a pivotal role in the process flow, converting raw data into a format that can be readily analyzed by the AI models. They work in tandem with the trained machine learning models to interpret and encode incoming data from the multimodal inputs. The encoders ensure that data is represented in a consistent and analyzable form, allowing for the integration of various data types and facilitating the seamless functioning of the AI framework.

The provisioning system 312 integrates the output from the AI models and encoders to manage and automate the workflow of applications 310. The AI system's predictions are utilized here to make informed decisions regarding the provisioning of resources and managing application workflows. It can approve or reject actions based on the analysis provided by the AI models, and it facilitates real-time adaptation to changing conditions or requirements within the system. End-point device(s) 140, which may include a display or a computer with input/output devices for user interface (UI), is/are an integral part of the process flow 300. The end-point device(s) 140 provides a means for users to interact with the AI system, offering an avenue to input commands, view system outputs, and receive notifications. The interface enables human users to make informed decisions when necessary, such as when the system requires human input for certain approvals or when managing exceptions that the AI system has flagged. This creates a data transfer relationship between the AI and human users, ensuring that the system benefits from the strengths of both artificial intelligence and human judgment.

It is understood that voice input integration represents a significant advancement in the system's interactive capabilities, allowing users to provide commands and inputs using natural speech. For example, in some embodiments, voice input integration is achieved using speech recognition libraries such as a Speech-to-Text API or Python's SpeechRecognition package, which allow for the conversion of spoken language into text. In certain embodiments, this capability is programmed into the system using languages such as Python or Java, which are known for their robust libraries and frameworks that support machine learning and AI development. Error detection and classification are programmed using machine learning algorithms, where deviations from standard operational patterns are identified. It is understood that these components may be built using Python with libraries like TensorFlow or PyTorch, allowing for complex data analysis and model training.

When errors are detected, the system's programmed functions for error resolution are initiated. In some embodiments, these functions are structured using rule-based systems programmed in Prolog or R, while in other embodiments, complex neural networks are employed to suggest and implement solutions. It is understood that the neural networks can be trained using reinforcement learning techniques, where the system learns optimal actions through trial and error interaction with a dynamic environment. The programming of these components involves a blend of technologies, including Natural Language Processing (NLP) engines and Computer Vision (CV) models, enabling the AI to understand text and images.

In terms of workflow automation, it is understood that programming languages such as Java and C#might be used, and in some embodiments in conjunction with SQL for database interactions, and RESTful APIs for application integration. This allows the AI system to interact with various entity applications and databases, managing workflows and data transactions. The system's virtual assistant component, which provides contextual assistance, may be developed using conversational AI platforms that include Dialogflow or a Bot Framework, which can be programmed to handle complex user queries and provide appropriate responses.

It is understood that the programming languages and tools chosen for developing these components are selected for their proven scalability and robustness in handling the vast data streams and complex computations required for the AI system. The continuous operation and learning capabilities of the AI are facilitated through the use of distributed computing environments like Apache Hadoop or Spark, which can process large volumes of data and perform complex algorithms quickly. The system's ability to adapt and learn is programmed using adaptive machine learning techniques, which require ongoing refinement of models as new data is ingested.

Each of these components interacts with one another through a carefully architected message-passing system, commonly built with the use of microservices architecture. This ensures that each component of the AI system operates in synchrony, providing real-time updates and adjustments to workflows as needed. The user interface, which allows users to interact with the AI, may be programmed using web development frameworks like Angular or React, which provide a dynamic and responsive interface for users to input commands and receive information from the AI system. This integration ensures that the users can effectively communicate with the AI system, enabling a seamless and efficient human-computer interaction.

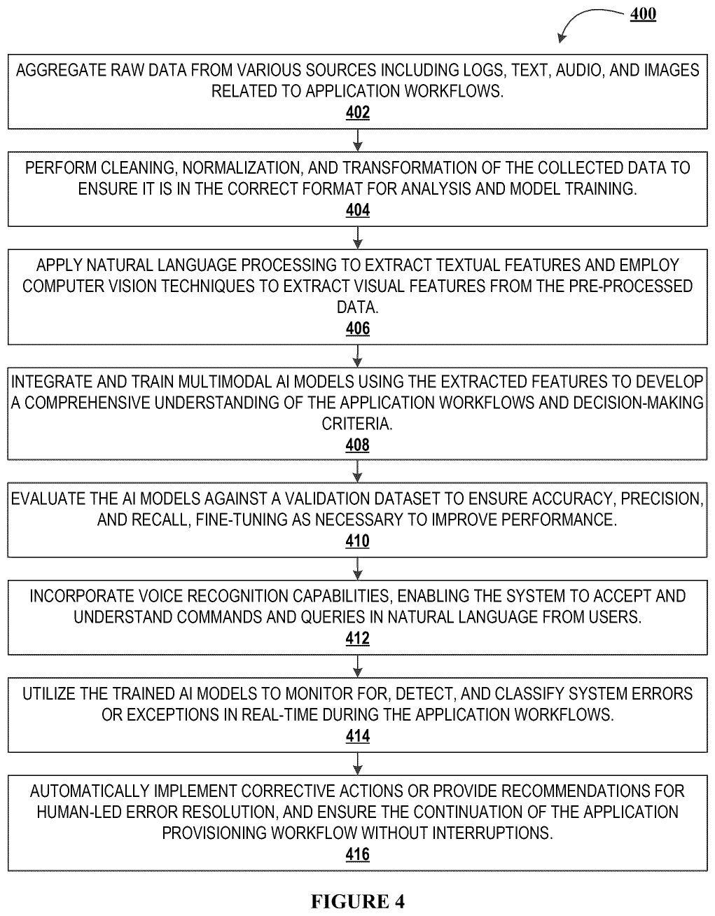

FIG. 4 illustrates a process flow 400 for an integrated multimodal artificial intelligence framework for automated provisioning systems, in accordance with an embodiment of the disclosure. As shown in block 402, the process begins by aggregating raw data from various sources including logs, text, audio, and images related to application workflows. This data aggregation is pivotal as it forms the foundational dataset upon which the AI system is trained. It includes collecting error reports, user command logs, auditory commands or feedback, and visual data such as user interface screenshots or application state images. The aggregation process is automated using scripts or software agents programmed in languages like Python or JavaScript, which can interact with multiple data sources and databases to retrieve and compile the necessary data.

As shown in block 404, the aggregated raw data undergoes a normalization and cleansing process. This step is crucial to ensure the consistency and quality of the data fed into the AI models. Normalization may include converting text to a standard format, scaling audio levels, or resizing images. Cleansing involves removing outliers, correcting errors, or filling in missing values, which could be executed using data preprocessing libraries in Python, such as Pandas or NumPy. These tools provide functions that automate the cleaning and normalization process, making the raw data more homogenous and suitable for analysis.

As shown in block 406, the process further continues by extracting features from the normalized data using specialized AI techniques. In this step, NLP techniques are applied to textual data to extract semantic information, while computer vision algorithms process images to identify key visual features. For audio data, features such as frequency and amplitude are extracted. This is typically done using machine learning libraries like scikit-learn for general feature extraction, TensorFlow or PyTorch for deep learning applications, and spaCy for NLP tasks.

As shown in block 408, the process further continues by integrating and training multimodal AI models using the extracted features to develop a comprehensive understanding of the application workflows and decision-making criteria. It is understood that this may be executed by employing fusion-based machine learning techniques that combine features from different data types to train a cohesive model. For example, in some embodiments, the system may use ensemble learning methods where multiple models such as Recurrent Neural Networks (RNNs) for temporal data, Convolutional Neural Networks (CNNs) for visual data, and transformers for sequential text data are trained separately and their outputs are then combined, or fused, to make a final prediction or classification. As such, in some embodiments, integration is performed within a development environment like Jupyter Notebook or PyCharm, utilizing machine learning frameworks such as TensorFlow or PyTorch, which support multimodal learning.

As shown in block 410, the process further continues by evaluating the AI models against a validation dataset to ensure accuracy, precision, and recall, fine-tuning as necessary to improve performance. The validation phase includes using techniques like k-fold cross-validation to mitigate overfitting and provide an unbiased evaluation of the model's performance. Metrics specific to the application's needs, such as the FI score for balancing precision and recall, are computed to measure the efficacy of the models. As such, in some embodiments, tools like MLflow or TensorBoard are used for tracking experiments, visualizing model performance, and facilitating the fine-tuning process.

As shown in block 412, the process further continues by incorporating voice recognition capabilities, enabling the system to accept and understand commands and queries in natural language from users. It is understood that Speech-to-text technologies are integrated into the system to convert spoken language into text data that the AI models can process. APIs from various services, or open-source alternatives like Mozilla's DeepSpeech, which leverage deep learning algorithms to recognize speech patterns, may be utilized in this step. The implementation involves setting up an API call that streams audio data to the service and receives the transcribed text, which is then fed into the AI models for further processing.

As shown in block 414, the process further continues by utilizing the trained AI models to monitor for, detect, and classify system errors or exceptions in real-time during the application workflows. Anomaly detection techniques are programmed into the models to identify outliers or patterns that deviate from the norm. In some embodiments, this could involve unsupervised learning algorithms that have been trained to recognize standard operational behavior, so deviations can be flagged for review. As such, the AI system continuously receives data inputs during the application workflow, allowing it to respond immediately when it identifies potential issues.

Finally, as shown in block 416, the process further continues by automatically implementing corrective actions or providing recommendations for human-led error resolution, and ensuring the continuation of the application provisioning workflow without interruptions. In some embodiments, this involves programming the AI models with the ability to execute pre-defined remediation tasks or issue alerts to operational teams for more complex issues. For example, if an error is detected during the deployment of an application, the system may either rollback to a previous state or alert a technician with detailed diagnostic information. Scripting languages like Python or Bash may be used to create the remediation scripts, and orchestration tools like Kubernetes or Ansible automate the deployment and operation of these scripts within the system's infrastructure, or the like.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### INCORPORATION BY REFERENCE

To supplement the present disclosure, this application further incorporates entirely by reference the following commonly assigned patent applications:

| | U.S. Patent | | |
|---|---|---|---|
| Docket Number | Application No. | Title | Filed On |
| 15857US1.014033.4936 | To be assigned | CRYPTOGRAPHIC HASH SIGNATURE | Concurrently |
| | | FOR ERROR PATTERN RECOGNITION | herewith |
| | | WITH AN AUTOMATED RECOVERY | |
| | | FRAMEWORK | |

What is claimed is:

1. A system for an integrated multimodal artificial intelligence framework for automated provisioning systems, the system comprising:
a processing device;
a non-transitory storage device containing instructions when executed by the processing device, causes the processing device to perform the steps of:
aggregating raw data from multiple data sources, wherein the data sources comprise logs, text, audio inputs, and visual inputs, resulting in aggregated raw data;
producing a pre-processed dataset via normalizing and cleansing the aggregated raw data;
determining extracted features from the pre-processed dataset using a combination of natural language processing for text data and computer vision for visual data;
integrating the extracted features into a multimodal AI model framework and training the multimodal AI model framework to recognize patterns and make decisions;
validating the trained multimodal AI model framework using a validation dataset to ensure model performance meets predetermined accuracy, precision, and recall benchmarks;
incorporating voice recognition capabilities to interpret natural language inputs from users and translate the natural language inputs into executable commands;
monitoring application workflows in real-time with the trained multimodal artificial intelligent (AI) model framework to detect and classify system errors or exceptions; and
executing a corrective action automatically or providing a recommendation for manual intervention to resolve the system errors or exceptions.

2. The system of claim 1, wherein aggregating raw data further comprises use of application programming interfaces (APIs) to automatically retrieve data from various application layers including user interfaces, middleware, and backend databases.

3. The system of claim 1, wherein normalizing and cleansing the aggregated raw data further comprises use of an outlier detection algorithms to identify and rectify anomalies within the data set.

4. The system of claim 1, wherein extracting features using natural language processing and computer vision further comprises applying recurrent neural networks for the text data and convolutional neural networks for the visual data.

5. The system of claim 1, wherein validating the trained multimodal AI model framework is performed continuously as part of an iterative development process, with each iteration refining the model based on feedback from an operational performance metric.

6. The system of claim 1, wherein the voice recognition capabilities comprise adapting to user-specific accents, dialects, and languages to improve the accuracy of voice-to-text conversions and system commands.

7. The system of claim 1, wherein executing corrective actions comprises an escalation protocol notifying a human operator when the error requires intervention other than a predetermined automated corrective measure.

8. A computer program product for an integrated multimodal artificial intelligence framework for automated provisioning systems, the computer program product comprising a non-transitory computer-readable medium comprising code causing an apparatus to:
aggregate raw data from multiple data sources, wherein the data sources comprise logs, text, audio inputs, and visual inputs, resulting in aggregated raw data;
produce a pre-processed dataset via normalizing and cleansing the aggregated raw data;
determine extracted features from the pre-processed dataset using a combination of natural language processing for text data and computer vision for visual data;
integrate the extracted features into a multimodal AI model framework and training the multimodal AI model framework to recognize patterns and make decisions;
validate the trained multimodal AI model framework using a validation dataset to ensure model performance meets predetermined accuracy, precision, and recall benchmarks;
incorporate voice recognition capabilities to interpret natural language inputs from users and translate the natural language inputs into executable commands;
monitor application workflows in real-time with the trained multimodal artificial intelligent (AI) model framework to detect and classify system errors or exceptions; and
execute a corrective action automatically or providing a recommendation for manual intervention to resolve the system errors or exceptions.

9. The computer program product of claim 8, wherein aggregating raw data further comprises use of application programming interfaces (APIs) to automatically retrieve data from various application layers including user interfaces, middleware, and backend databases.

10. The computer program product of claim 8, wherein normalizing and cleansing the aggregated raw data further comprises use of an outlier detection algorithms to identify and rectify anomalies within the data set.

11. The computer program product of claim 8, wherein extracting features using natural language processing and computer vision further comprises applying recurrent neural networks for the text data and convolutional neural networks for the visual data.

12. The computer program product of claim 8, wherein validating the trained multimodal AI model framework is performed continuously as part of an iterative development process, with each iteration refining the model based on feedback from an operational performance metric.

13. The computer program product of claim 8, wherein the voice recognition capabilities comprise adapting to user-specific accents, dialects, and languages to improve the accuracy of voice-to-text conversions and system commands.

14. The computer program product of claim 8, wherein executing corrective actions comprises an escalation protocol notifying a human operator when the error requires intervention other than a predetermined automated corrective measure.

15. A method for an integrated multimodal artificial intelligence framework for automated provisioning systems, the method comprising:
aggregating raw data from multiple data sources, wherein the data sources comprise logs, text, audio inputs, and visual inputs, resulting in aggregated raw data;
producing a pre-processed dataset via normalizing and cleansing the aggregated raw data;
determining extracted features from the pre-processed dataset using a combination of natural language processing for text data and computer vision for visual data;
integrating the extracted features into a multimodal AI model framework and training the multimodal AI model framework to recognize patterns and make decisions;
validating the trained multimodal AI model framework using a validation dataset to ensure model performance meets predetermined accuracy, precision, and recall benchmarks;
incorporating voice recognition capabilities to interpret natural language inputs from users and translate the natural language inputs into executable commands;
monitoring application workflows in real-time with the trained multimodal artificial intelligent (AI) model framework to detect and classify system errors or exceptions; and
executing a corrective action automatically or providing a recommendation for manual intervention to resolve the system errors or exceptions.

16. The method of claim 15, wherein aggregating raw data further comprises use of application programming interfaces (APIs) to automatically retrieve data from various application layers including user interfaces, middleware, and backend databases.

17. The method of claim 15, wherein normalizing and cleansing the aggregated raw data further comprises use of an outlier detection algorithms to identify and rectify anomalies within the data set.

18. The method of claim 15, wherein extracting features using natural language processing and computer vision further comprises applying recurrent neural networks for the text data and convolutional neural networks for the visual data.

19. The method of claim 15, wherein the voice recognition capabilities comprise adapting to user-specific accents, dialects, and languages to improve the accuracy of voice-to-text conversions and system commands.

20. The method of claim 15, wherein executing corrective actions comprises an escalation protocol notifying a human operator when the error requires intervention other than a predetermined automated corrective measure.
